(19) United States
(12) Patent Application Publication
(10) Pub. No.: US 2012/0006020 A1
(43) Pub. Date: Jan. 12, 2012

(54) METHODS AND SYSTEMS FOR POWERING A COMPRESSOR TURBINE

(76) Inventor: Karim Wahdan, Cary, NC (US)

(21) Appl. No.: 13/083,528

(22) Filed: Apr. 8, 2011

Related U.S. Application Data
(60) Provisional application No. 61/322,849, filed on Apr. 10, 2010.

(51) Int. Cl. F02B 37/04; F01K 23/16; F02B 37/12

(52) U.S. Cl. 60/608; 60/607; 60/653

(57) ABSTRACT

Methods and apparatuses for powering a compressor turbine are provided. The shared shaft between an exhaust gas turbine and the compressor may operates more effectively with the addition an additional component such as a steam turbine to help control the speed of the shaft.

### CROSS-REFERENCE TO RELATED APPLICATIONS

This application claims the benefit of U.S. Provisional Application Ser. No. 61/322,849, which was filed on Apr. 10, 2010, and is incorporated herein by reference in its entirety.

### FIELD

The present invention relates to compressor turbines.

### BACKGROUND

FIG. 1 illustrates a conventional turbo charger 100. A conventional turbo charger 100 includes an exhaust gas turbine 110 and a compressor turbine 120 connected to each other by a shaft 130. The exhaust gas turbine 110 uses the exhaust flow 160 from the engine exhaust manifold 150 to rotate the shared shaft 130 thereby powering the compressor turbine 120. The compressor turbine 120 raises the pressure of incoming ambient air 170 and delivers the compressed air 180 to the engine intake system 190. The increased incoming air pressure to the engine intake system 190 increases the power output of the engine 140.

However, at low speeds the exhaust flow 160 from the engine exhaust manifold 150 is low thereby causing the exhaust gas turbine 110 to operate inefficiently. That is, at low speeds the exhaust gas turbine 110 cannot effectively rotate the shared shaft 130 to power the compressor turbine 120. The exhaust gas turbine 110 operates at high speeds (e.g., 100,000 to 130,000 RPM) to effectively power the compressor turbine 120; at low speeds, there is insufficient exhaust mass flow 160 to produce such exhaust gas turbine 110 speeds. Thus, at low speeds, the compressor turbine 120 cannot effectively provide high pressure air 180 to the engine intake system 190 to increase the power output of the engine 140. Accordingly, when an automobile accelerates, it takes several engine revolutions to increase the exhaust flow 160 so that the exhaust gas turbine 110 may operate effectively to rotate the shared shaft 130 and power the compressor 120. This phenomenon is referred to as turbo lag or spooling.

### BRIEF DESCRIPTION OF THE DRAWINGS

FIG. 1 illustrates a conventional turbo charger.

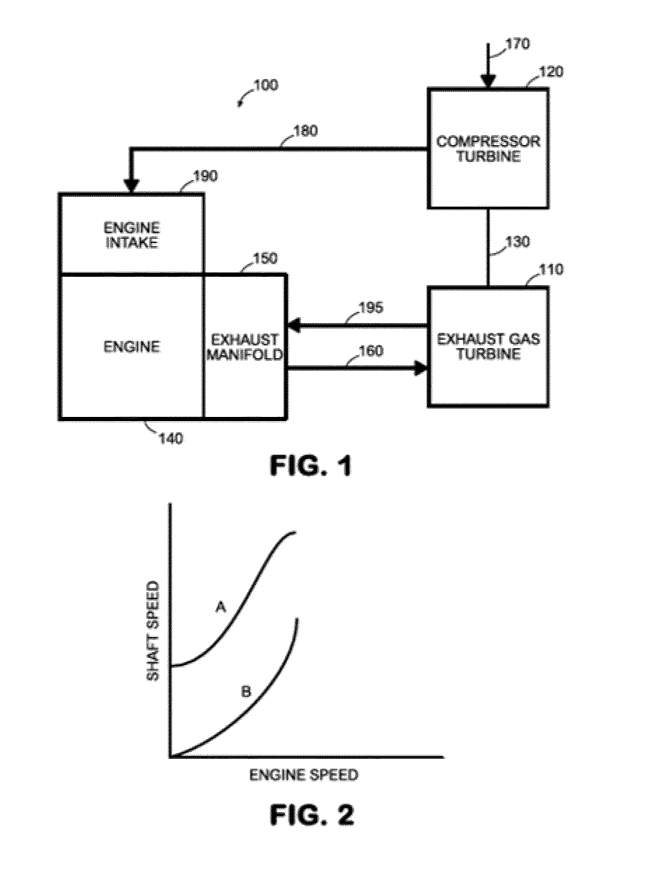

FIG. 2 illustrates graphs of the shaft speed as a function of engine speed of a conventional turbo charger and a turbo charger based on the principles of the present invention.

FIGS. 3A and 3B illustrate an exemplary embodiment of a turbo charger according to the principles of present invention.

FIG. 4 illustrates an exemplary embodiment of a system to generating superheated steam for a turbo charger according to the principles of present invention.

FIG. 5 illustrates an exemplary embodiment of a heat exchanger.

FIG. 6 illustrates an exemplary embodiment of a controller operable to control various components of a turbo charger according to the principles of present invention.

### DETAILED DESCRIPTION

Embodiments of the present invention may improve the efficiency of the conventional turbo charger. Embodiments of the present invention may constantly power a compressor turbine, which in turn may constantly supply high pressure air to an engine intake system.

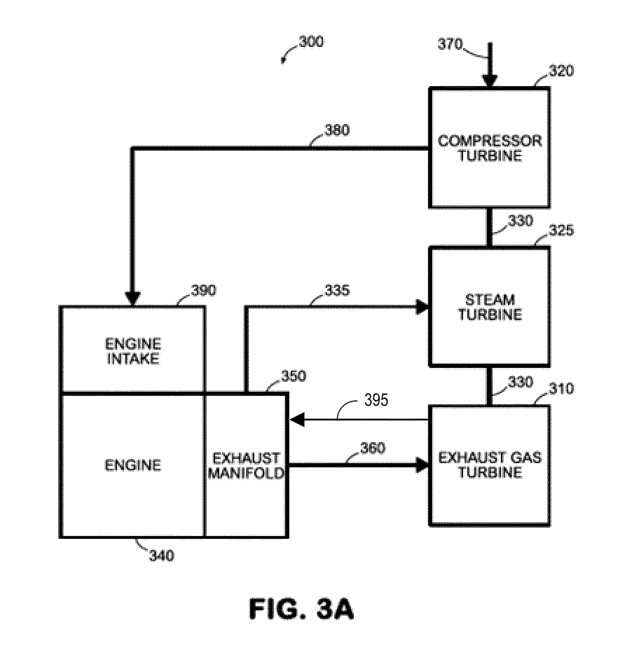

FIG. 2 compares the speed of the shared shaft 130 of a conventional turbo charger 100 (graph B) and the speed of a shared shaft of a turbo charger based on the principles of the present invention (graph A). As shown in FIG. 2, by utilizing the principles of the present invention, the shared shaft of a turbo charger based on the principles of the present invention may rotate at low engine speeds, which may more effectively power a compressor turbine and thereby more effectively supply high pressure air to an engine intake system to increase the power output of an engine. For example, the shared shaft of a turbo charger based on the principles of the present invention may constantly rotate thereby constantly powering the compressor turbine and constantly supplying high pressure air to the engine intake system to increase the power output of the engine. Because the shared shaft of a turbo charger based on the principles of the present invention may constantly rotate, embodiment of the present invention may, among other things, reduce or eliminate turbo lag/spooling.

Some embodiments of the present invention include an additional turbine powered by superheated steam, which may more effectively power a compressor turbine. The steam turbine is connected to the shared shaft 130 of the conventional exhaust gas turbine 110 and compressor turbine 120. Heat from a variety of sources may be used to generate the superheated steam that powers the steam turbine to rotate the shared shaft 130. For example, heat from the engine 140, a heat exchanger, the engine exhaust manifold 150, the exhaust gas turbine 110, the compressor turbine 120, any combination of the foregoing, or any other source may be used to generate the superheated steam that powers the steam turbine.

Because the temperature of the engine exhaust manifold 150 may not significantly vary with varying engine RPM and engine loads, a constant working fluid temperature may be used (e.g., by manipulating the mass flow rate of the working fluid passing through the engine exhaust manifold 150) to produce a constant supply of superheated steam to power the steam turbine and rotate the shared shaft 130. As a result, the shared shaft 130 may rotate at low engine speeds, which may more effectively power the compressor turbine 120 and thereby more effectively supply high pressure air to the engine intake system 190 to increase the power output of the engine 140.

Thus, the steam turbine may create a minimum threshold of boost (i.e., increased power) to the engine 140. At low speeds, the compressor turbine 120 may be powered substantially by the steam turbine because, as discussed above, the conventional exhaust gas turbine 110 does not operate effectively. At medium speeds, the exhaust gas turbine 110 may be used in conjunction with the steam turbine to power the compressor turbine 120 and provide greater boost to the engine 140. At high speeds, exhaust flow 160 from the engine is high, thus, the steam turbine may be shut down and the conventional exhaust gas turbine 110 may operate in the conventional manner to power the compressor turbine 120. However, the steam turbine and the exhaust gas turbine 120 may be programmed to operate in a variety of ways based on desired performance criteria.

Embodiments of the present invention also may reduce undesirable exhaust blow back 195 caused by back pressure. Exhaust blow back 195 affects the engine's performance and emission and may occur at low and high speeds. However, back pressure 195 caused by the conventional turbo charger 100 at high speeds may be acceptable because of the engine boost produced at high speeds by the conventional turbo charger 100. That is, at high speeds, the tradeoff of back pressure 120 for engine boost may be acceptable. But, because there is ineffective engine boost at low speeds, back pressure 195 caused by the conventional turbo charger 100 at low speeds may be unacceptable. In other words, there may be no tradeoff at low speeds for the back pressure caused by the conventional turbo charger 100. The back pressure 195 caused by the conventional turbo charger 100 at low speeds may be one of the main reasons turbo chargers are not more common place in automobiles.

Existing exhaust gas turbines 110 that use variable geometry vanes also can create back pressure at low speeds because the vanes must be open and rotating to rotate the shared shaft 130 to overcome turbo lag/spooling. Because the steam turbine in embodiments of the present invention rotate the shared shaft 130 at low speeds, the exhaust gas turbine 110 may not be needed to rotate the shared shaft 130 at low speeds. Accordingly, the vanes of the exhaust gas turbine 110 may be closed so that the exhaust gas 160 may pass through the exhaust gas turbine 110 without powering it thereby reducing or eliminating back pressure typically caused by the exhaust gas turbine 110 at low speeds.

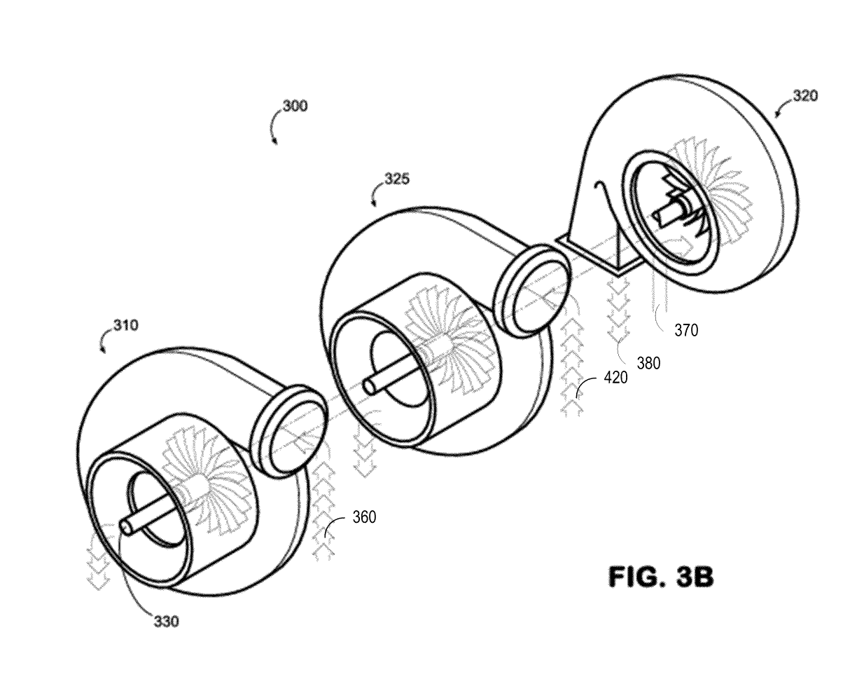

FIGS. 3A and 3B illustrate an exemplary embodiment of a turbo charger 300 according to the principles of present invention. The turbo charger 300 includes an exhaust gas turbine 310, a compressor turbine 320, and a steam turbine 325, which are all connected to a common shaft 330. Although FIGS. 3A and 3B illustrate the turbines in a particular order with respect to each other, the exhaust gas turbine 310, compressor turbine 320, and steam turbine 325 may be arranged in any suitable manner.

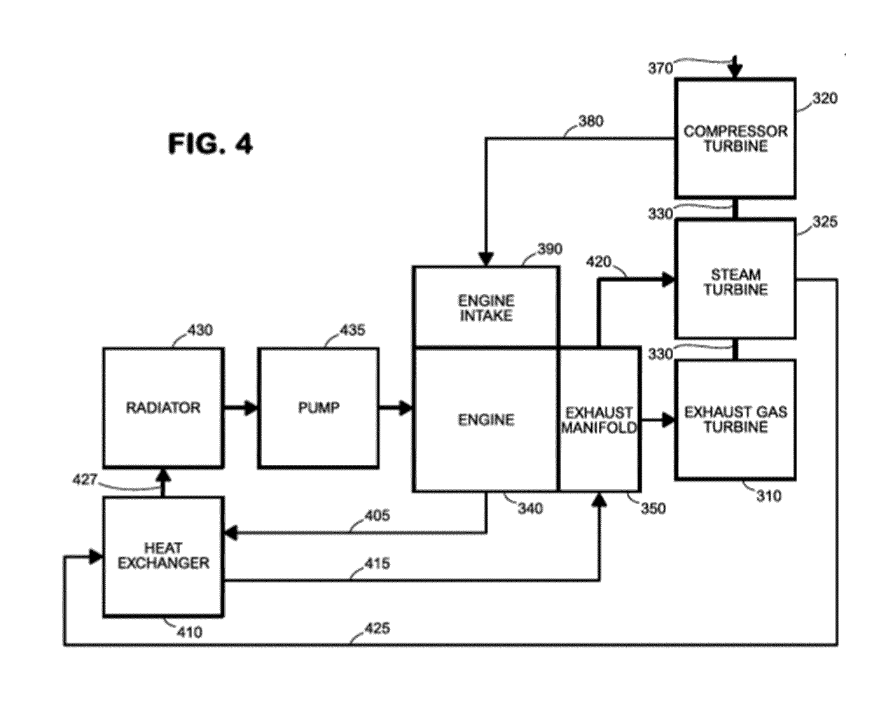

At low speeds, the steam turbine 325 uses superheated steam supplied, for example, via a steam line 335 to rotate the shared shaft 330 to power the compressor turbine 320. In some embodiments, superheated steam is generated by heating a liquid such as water or any appropriate liquid. Referring to FIG. 4, in some embodiment, superheated steam is generated by taking water 405 exiting the engine 340 at approximately 98° C. and heating it to 100° C., for example, using a heat exchanger 410. In an alternate embodiment, the water exiting the engine 405 may be heated to any suitable temperature. The water 415 exiting the heat exchanger 410 then may pass through the exhaust manifold 350, which may boil the water and convert it to superheated steam 420. The superheated steam 420 then may be used to operate the steam turbine 325. The water exiting the steam turbine 425 may be returned to the heat exchanger 410 to lower the temperature of the water before passing the water 427 to the radiator 430. The water then may be returned to the engine 340 via the radiator 430 and a pump 435 and the cycle may repeat.

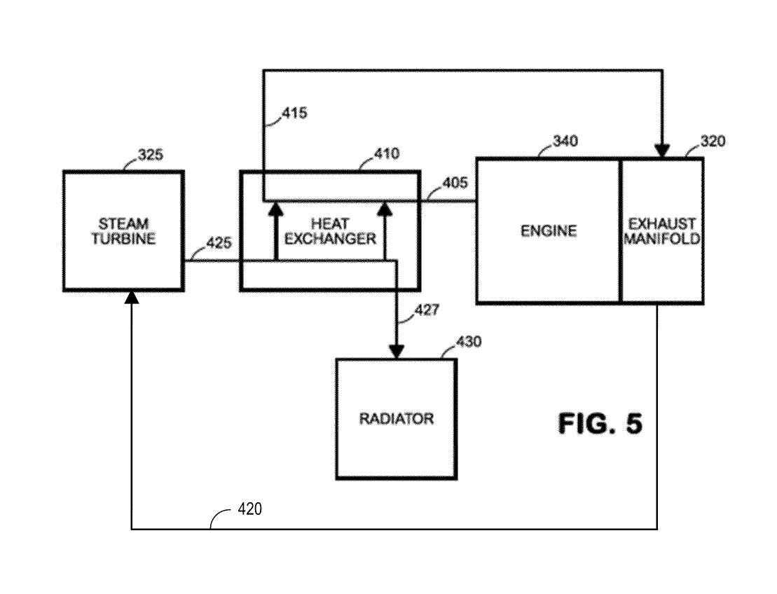

As shown in FIG. 5, in one embodiment, the heat exchanger 410 heats the water 405 exiting the engine 340 to 100° C. or any suitable temperature by extracting the heat from the superheated water 425 from the steam turbine 325. In an alternate embodiment, the water 405 exiting the engine 340 is heated to 100° C. or any suitable temperature by extracting the heat from the exhaust gas turbine and/or the compressor turbine before being passing to the engine exhaust manifold.

In some embodiments, the steam turbine 325 uses superheated steam generated by heating water or other suitable fluid from another source other than the engine and utilizing the heat of the exhaust system and exhaust pipes. More specifically, the fluid cycle will extract heat from the exhaust gases passing through the exhaust pipes at a point after the catalytic converter to increase temperature of the fluid to a boiling point. The working fluid may then pass through the exhaust manifold 350 to convert it to superheated steam 420. The superheated steam 420 then may be used to operate the steam turbine 325. The working fluid after expanding in the steam turbine 325 may pass through a radiator to reduce the fluid to liquid saturated point and the liquid is then pumped through the cycle again.

In some embodiments, the engine 340 can be any internal combustion engine. In a two stroke combustion engine, for example, the principles of the present invention can help to provide a clean air/fuel mixture in the combustion chamber of the engine thereby reducing scavenging and allow for a higher compression ratio in the engine thereby enabling the engine to produce more power.

A cleaner air/fuel mixture may be achieved due to the constant boost provided using the principles of the present invention. The compressed air from the compressor turbine may flow with higher pressure than the exhaust gases in the cylinder of the engine thereby displacing and clearing the exhaust gases and hence providing a cleaner air/fuel mixture in the combustion chamber of the engine.

The working fluid 415 extracts heat from the exhaust manifold 350 thereby cooling the exhaust gases from engine 340 and the exhaust blow back 395 passing through the exhaust manifold 350. This results in a temperature reduction in the combustion chamber of the engine, which allows the engine manufacturer to increase the compression ratio in the engine hence allowing the engine to produce more power. The combustion chamber temperature reduction can be realized for both 2 stroke and 4 stroke engines.

In some embodiments, the steam turbine 325 may be replaced by any device that uses any form of recovering energy to maintain a minimum speed of the rotating shared shaft 330. For example, an electrolyzer or any device that converts heat into electricity and powers the rotating shaft 330 to constantly provide boost may be used. In some embodiments, the steam turbine 325 or the electric powered device may completely replace the exhaust gas turbine 310 to power the compressor turbine 320 at all speeds.

Sensors may be placed throughout embodiments of the turbo charger of the present invention. For example, to monitor conditions, sensors may be located in the steam turbine 325, exhaust gas turbine 310, compressor turbine 320, engine intake system 390, engine 340, engine exhaust manifold 350, heat exchanger 410, radiator 430, pump 435, or any other component. The sensors may transmit readings to a controller, which controls the various components of the turbo charger (e.g., exhaust gas turbine 310 and steam turbine 325) based on conditions. For example, a sensor may monitor the exhaust gas 360 flow rate and transmit the reading to a controller. The controller may open the vanes of the exhaust gas turbine 310 when the exhaust gas flow rate is sufficient to effectively operate the compressor 320. The controller may also shut down the steam line 335 that supplies steam to the steam turbine 325. Accordingly, when the exhaust gas flow rate is sufficient to effectively operate the exhaust gas turbine 310, the controller may open the vanes of the exhaust gas turbine 310 and shut down the steam line 335 that supplies steam to the steam turbine 325 so that the compressor 320 may be powered only by the exhaust gas turbine 310. The controller may be programmed to operate in numerous ways to control the exhaust gas turbine 310 and steam turbine 325 based on desired performance criteria.

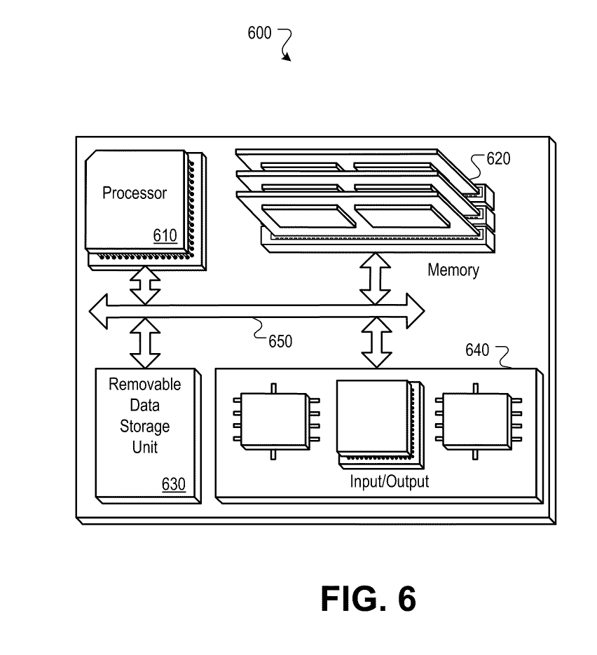

FIG. 6 illustrates an example controller 600 operable to control the various components of the turbo charger (e.g., the exhaust gas turbine 310 and steam turbine 325) based on conditions. The controller 600 can include a processor 610, a memory 620, a removable data storage unit 630, and, an input/output device 640. Each of the components 610, 620, 630, and 640 can, for example, be interconnected using a system bus 650. In some implementations, the controller 600 can include one of more interconnected boards where each board comprises components 610, 620, 630, and 640. The processor 610 is capable of processing instructions for execution within the controller 600. For example, the processor 610 can be capable of processing instructions for controlling the various components of the turbo charger (e.g., the exhaust gas turbine 310 and steam turbine 325). In some implementations, the processor 610 is a single-threaded processor. In other implementations, the processor 610 is a multi-threaded processor. The processor 610 is capable of processing instructions stored in the memory 620 or on the storage device 630.

The memory 620 stores information within controller 600. In some implementations, the memory 620 is a computer-readable medium. In other implementations, the memory 620 is a volatile memory unit. In still other implementations, the memory 620 is a non-volatile memory unit.

In some implementations, the storage device 630 is capable of providing mass storage for controller 600. In one implementation, the storage device 630 is a computer-readable medium. In various different implementations, the storage device 630 can, for example, include a hard disk device, an optical disk device, flash memory or some other large capacity storage device. The input/output device 640 provides input/output operations for the controller 600.

Implementations of the controller 600 can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Many modifications and other embodiments of the invention will come to mind to one skilled in the art to which this invention pertains having the benefit of the teachings presented in the forgoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Reference throughout this specification to “an embodiment,” “one embodiment”, or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Furthermore, the described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

What is claimed:

1. A turbo charger comprising:
a steam turbine;
an exhaust gas turbine;
a compressor turbine;
a shaft connected the steam turbine, the exhaust gas turbine, and the compressor turbine; and
a controller;
wherein the exhaust gas turbine is configured to use exhaust flow from an engine exhaust manifold to rotate the shaft;
wherein the steam turbine is configured to use superheated steam to rotate the shaft; and
wherein the controller is configured to control the steam turbine and the exhaust gas turbine such that the shaft is substantially controlled by the steam turbine for speeds lower than a first speed and substantially controlled by the exhaust gas turbine for speeds greater than the a second speed.

2. The turbo charger of claim 1 wherein the controller is configured to control the steam turbine and the exhaust gas turbine such that the shaft is controlled solely by the steam turbine for speeds lower than a first speed and controlled solely by the exhaust gas turbine for speeds greater than the a second speed.

3. A method of generating superheated steam comprising:
receiving superheated water;
receiving water at a first temperature; and
extracting the heat from the superheated water to heat the water at the first temperature to a second temperature.

4. The method of claim 3, wherein the superheated water is received from a steam turbine and the water at the first temperature is received from an engine.

5. The method of claim 4 further comprising delivering the water at the second temperature to an engine exhaust manifold.

6. A turbo charger comprising:
a first component;
an exhaust gas turbine;
a compressor turbine;
a shaft connected the first component, the exhaust gas turbine and the compressor turbine wherein the exhaust gas turbine is configured to use exhaust flow from an engine exhaust manifold to rotate the shaft and wherein the first component is configured to use recovering energy to rotate the shaft; and
a controller wherein the controller is configured to control the first component and the exhaust gas turbine such that the shaft is substantially controlled by the first component for speeds lower than a first speed and substantially controlled by the exhaust gas turbine for speeds greater than the a second speed.

7. The turbo charger of claim 6 wherein the controller is configured to control the first component and the exhaust gas turbine such that the shaft is controlled solely by the first component for speeds lower than a first speed and controlled solely by the exhaust gas turbine for speeds greater than the a second speed.

8. The turbo charger of claim 6 wherein the first component is a steam turbine.

9. The turbo charger of claim 6 wherein the first component is an electrolyzer.

10. The turbo charger of claim 6 wherein the first component is a device that converts heat into electricity.

11. The turbo charger of claim 6 wherein the first component is a turbine powered by electricity.

12. A turbo charger comprising:
a steam turbine; and
a compressor turbine; and
a shaft connected the steam turbine and a compressor turbine;
wherein the steam turbine is configured to use superheated steam to rotate the shaft.

13. A turbo charger comprising:
a first component configured to use recovering energy to rotate a shaft; and
a compressor turbine;
wherein the shaft is connected to the first component and the compressor turbine.

14. The turbo charger of claim 13 wherein the first component is a steam turbine.

15. The turbo charger of claim 13 wherein the first component is an electrolyzer.

16. The turbo charger of claim 13 wherein the first component is a device that converts heat into electricity.

17. The turbo charger of claim 13 wherein the first component is a turbine powered by electricity.

18. A turbo charger comprising:
a steam turbine wherein the steam turbine is configured to use superheated steam to rotate a shaft;
an electric turbine wherein the electric turbine is configured to use electricity to rotate the shaft; and
a compressor turbine;
wherein the shaft is connected to the steam turbine, electric turbine, and the compressor turbine.
